(19) United States
(12) Patent Application Publication
(10) Pub. No.: US 2015/0322873 A1
(43) Pub. Date: Nov. 12, 2015

(54) FUEL-SAVING SELF-ADJUSTING SYSTEM FOR A VEHICLE ENGINE

(71) Applicant: XIAMEN KING LONG UNITED AUTOMOTIVE INDUSTRY CO., LTD., Xiamen (CN)

(72) Inventors: Xiaobing Chen, Xiamen (CN); Yifan Xu, Xiamen (CN); Fangming Zhou, Xiamen (CN); Weihong Ye, Xiamen (CN); Wei Li, Xiamen (CN); Guoqiang Chen, Xiamen (CN); Lei Huang, Xiamen (CN)

(21) Appl. No.: 14/801,832

(22) Filed: Jul. 17, 2015

Related U.S. Application Data
(63) Continuation-in-part of application No. 13/772,213, filed on Feb. 20, 2013.

(51) Int. Cl. F02D 29/02

(52) U.S. Cl. CPC F02D 29/02

(57) ABSTRACT

A fuel-saving self-adjusting system for a vehicle engine adapted to the actual conditions of a road, including an information center and a plurality of onboard computers respectively mounted on a plurality of vehicles. Each of the onboard computers has a vehicle controlling module for adjusting a response of the engine of each vehicle so as to reduce adverse influences of improper driving manners. An optimized standard road resistance characteristic coefficient is applied as a more reliable reference to reduce the fuel consumption of the vehicle efficiently.

### CROSS-REFERENCE TO RELATED APPLICATION

This is a continuation-in-part of co-pending U.S. patent application Ser. No. 13/772,213 filed on Feb. 20, 2013 and owned by the present applicant.

(A) Technical Field of the Invention

The present invention relates to the control of a vehicle engine by a self-adjusting system to save fuel in accordance with the actual conditions of a vehicle driving on the rod. By controlling the engine, consumption of fuel is efficiently reduced while the vehicle remains powerfully operated.

(B) Description of the Prior Art

According to a dynamic response characterized of an engine, when the position of a pedal does not change abruptly, the dynamic relationship between an engine torque and an engine rotation speed tends to be linearly curved. However, if the accelerator pedal incurs a step change, experiments show that when the accelerator pedal provides a 100% step change, the fuel consumption increases, and the exhaust becomes deteriorated.

While starting, accelerating, and shifting gears, drivers often step the accelerator pedal heavily in order to speed up the vehicle in a short period of time. When the vehicle runs at an expected speed, drivers then slack the accelerator pedal. Such a driving manner is adverse to the engine, because a lot of fuel is not completely consumed. As a result, the fuel consumption increases. Moreover, since the torque of the engine increases transiently, the over-accelerated speed results in an overshoot, which needs a brake to decelerate. The energy is thus wasted. An economical fuel-saving driving manner would be that the accelerator pedal is gently stepped, and frequent acceleration or deceleration is avoided or substantially reduced.

The present invention is to optimize the high fuel consumption in view of the improper driving manners.

### SUMMARY OF THE INVENTION

The first object of the present invention is to provide a self-adjusting system for a vehicle engine in accordance with the practical driving conditions of a vehicle to decrease the fuel consumption while the vehicle maintains powerfully operated.

The self-adjusting system comprises an information center and a plurality of onboard computers respectively mounted on a plurality of vehicles to be in communication connection with the information center.

Each of the onboard computers comprises:

a global positioning system (GPS) module that acquires information of a current location of the vehicle and sends the information to the information center;

a driving data collecting module that collects driving data of the vehicle, including vehicle speed, engine speed, engine torque, a position of an accelerator pedal, and a position of a brake pedal;

a vehicle parameter and engine data module that stores therein vehicle configuration parameters and engine operation parameters corresponding to various values of power;

a computing module that computes current driving parameters based on the driving data from the driving data collecting module; the current driving parameters including vehicle acceleration, a change rate of the accelerator pedal position, and a gear of the vehicle, the computing module working on the vehicle configuration parameters from the vehicle parameter and engine data module so as to figure out a current road resistance characteristic coefficient;

a decision module that determines power required of the vehicle according to a standard road resistance characteristic coefficient from a route-optimized module, current road information from a map data module, and the current driving parameters from the computing module and retrieves corresponding engine operation parameters from the vehicle parameter and engine data module in accordance with the power required of the vehicle; and

a vehicle controlling module that receives the engine operation parameters and controls an output of the engine.

The information center comprises:

a map data module that stores map information and retrieves the current road information in accordance with the information of the current location of the vehicle from the GPS module;

a history data module that is in communication connection with the onboard computers of the plurality of vehicles to receive and store the current road resistance characteristic coefficient computed by the computing module of the onboard computer of each of the vehicle that was passing the road recently, the history data module conducting analysis and comparison of the current road resistance characteristic coefficients from the plurality of onboard computers of the plurality of vehicles; and

a route-optimized module connected with the history data module to retrieve the standard road resistance characteristic coefficient corresponding to the current road information and sending the standard road resistance characteristic coefficient corresponding to the current location to the decision module of the onboard computer of the vehicle.

Preferably, each onboard computer includes a human-machine interface module for drivers to input the driving data that includes a vehicle load and a state of the road; the decision module determines the power required of the vehicle according to the current road information, the standard road resistance characteristic coefficient, and the current driving parameters.

Preferably, the vehicle configuration parameters include a ratio of gearbox, a ratio of final drive, a maximum total mass of the vehicle, a wheel rolling radius, transmission efficiency, a coefficient of the revolving mass changes to a linear mass, a drag coefficient, and a frontal area.

Preferably, the current road information includes a gradient, a pavement condition, road information, and dynamic traffic information.

The second object of the present invention is to provide a method to save fuel in accordance with an actual driving state of a vehicle, comprising a step of collection and record optimization and a step of execution. The step of collection and record optimization includes:

(A1) presetting, in an onboard computer of each of vehicles, configuration parameters of the vehicle and operation parameters of an engine corresponding to the power required of the vehicle and presetting map information related to a traveling area of the vehicle in an information center; and

(A2) allowing the onboard computer of each of the vehicles to collect current road information, which is used in combination with the configuration parameters of the vehicle to compute current driving parameters and a current road resistance characteristic coefficient; allowing the onboard computer to retrieve information of a current location of the vehicle; sending a combination of the current road resistance characteristic coefficient and the current location of the vehicle to the information center to be saved as history data, generating a standard road resistance characteristic coefficient corresponding to the current road.

The step of execution includes:

(B1) retrieving the standard road resistance characteristic coefficient corresponding to the current location of the vehicle;

(B2) using the current road information, the current driving parameters, and the standard road resistance characteristic coefficient to compute the power required of the vehicle and the operation parameters of the engine in accordance with the power required; and

(B3) controlling an output of the engine in accordance with the operation parameters of the engine.

Preferably, step (A1) further comprises a step of providing a human-machine interface module for drivers to input the driving data that includes a vehicle load and a state of the road; in step (A2), the vehicle load is used in combination in computing the current driving parameters; in step (B2) the road information, the standard road resistance characteristic coefficient, and the current driving parameters are used in combination to determine the power required of the vehicle.

Preferably, the vehicle configuration parameters include a ratio of gearbox, a ratio of final drive, a maximum total mass of the vehicle, a wheel rolling radius, transmission efficiency, a coefficient of the revolving mass changes to a linear mass, a drag coefficient, and a frontal area.

Preferably, the road information includes vehicle speed, engine speed, engine torque, a position of an accelerator pedal, and a position of a brake pedal and the current driving parameters include a resistance, an acceleration of the vehicle, a change rate of the accelerator pedal position, and a gear of the vehicle.

Preferably, the current road information includes a gradient, a pavement condition, a road information, and dynamic traffic information.

Accordingly, the history data module records and summarizes the road resistance characteristic coefficients computed by the onboard computers of all the vehicles, so that corresponding standard road resistance characteristic coefficients are retrievable after further analysis. Subsequently, the decision module computers the power required of the vehicle according to the current driving parameters, the standard road resistance characteristic coefficient, and the current road information. The operation parameter of the engine are correspondingly retrieved from the vehicle parameter and engine data module in accordance with the power required of the vehicle and executed by the vehicle controlling module. When the vehicle controlling module orders an adjustment to the response of the engine, adverse influences from improper driving manners are reduced. Moreover, the standard road resistance characteristic coefficient is an optimized value obtained from many vehicles. Therefore, the standard road resistance characteristic coefficient is more reliable. Consequently, when the vehicle keeps being powerful, the output of the engine is efficiently controlled and the fuel consumption is decreased.

### BRIEF DESCRIPTION OF THE DRAWINGS

FIG. 1 is a block diagram showing a self-adjusting system in accordance with an actual driving state of a running vehicle.

FIG. 2 is a block diagram showing components in an onboard computer of the self-adjusting system.

FIG. 3 is a block diagram showing components in an information center of the self-adjusting system.

### DETAILED DESCRIPTION OF THE PREFERRED EMBODIMENTS

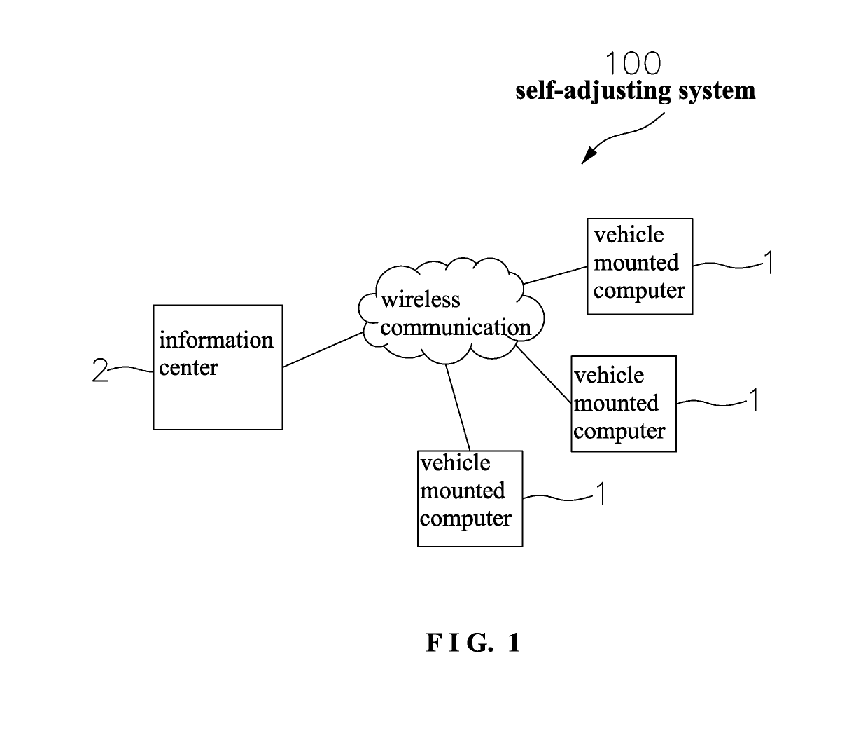

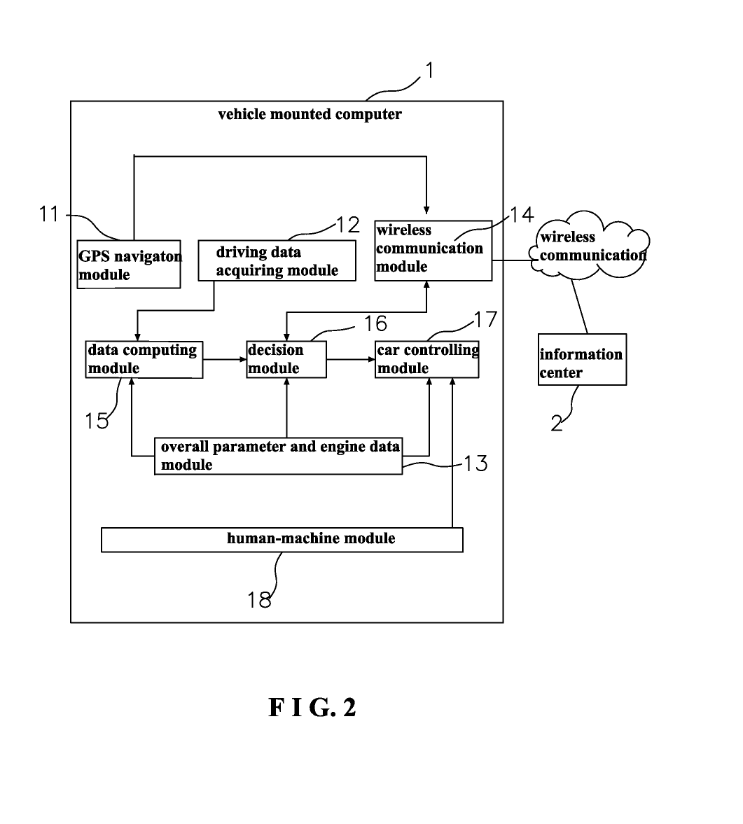

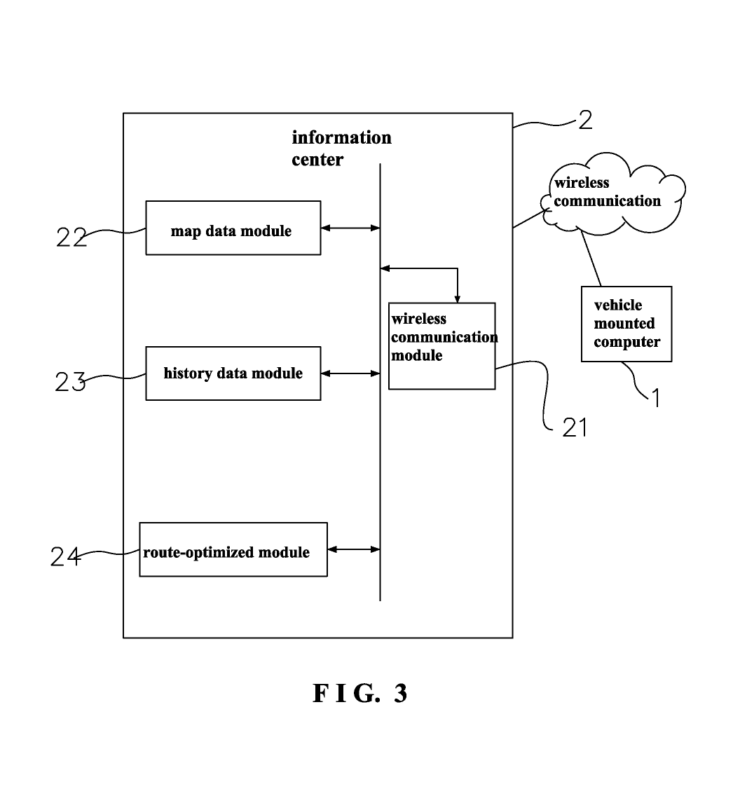

Referring to FIGS. 1-3, a block diagram of an engine providing a self-adjusting system 100 in accordance with an actual driving state of a vehicle is shown. The self-adjusting system 100 comprises an information center 2 and a plurality of onboard computers 1 that are respectively mounted on a plurality of vehicles and in communication connection with the information center 2.

Each onboard computer 1, which is installed in a specific vehicle, includes a GPS module 11, a driving data collecting module 12, a vehicle parameter and engine data module 13, a wireless communication module 14, a computing module 15, a decision module 16, and a vehicle controlling module 17. The information center 2 includes a wireless communication module 21, a map data module 22, a history data module 23, and a route-optimized module 24.

The GPS module 11 receives information of the current location of the vehicle. The GPS module 11 comprises a GPS antenna and a GPS receiver that receives the information of the current location of the vehicle. The information is further sent to the information center 2 for achieving positioning of vehicle in the map data module 22.

The driving data collecting module 22 collects driving data of the vehicle. The driving data of the vehicle includes a vehicle speed, an engine speed, an engine torque, a position of an accelerator pedal, and a position of a brake pedal. The driving data of the vehicle can be directly acquired via a CAN bus on the vehicle. For vehicles that are not provided with a CAN bus, sensors are needed for detecting and retrieving the driving data.

The vehicle parameter and engine data module 13 stores configuration parameters of the vehicle and operation parameters of an engine according to the power required. The configuration parameters of the vehicle includes a ratio of a gearbox, a ratio of final drive, a maximum total mass of the vehicle, a wheel rolling radius, a transmission efficiency, a coefficient of the revolving mass changes to a linear mass, a drag coefficient, and a frontal area. Moreover, the operation parameters of the engine are previously and correspondingly set to the current operation parameters of the engine of the specific vehicle. The engine operation parameters might be different when the power required changes.

The computing module 15 computes current driving parameters according to the driving data from the driving data collecting module 12. The current driving parameters include an acceleration of the vehicle, a change rate of the accelerator pedal position, and a gear of the vehicle. The computing module 15 works on the configuration parameters of the vehicle from the vehicle parameter and engine data module 13 to figure out a current road resistance characteristic coefficient.

The decision module 16 obtains a standard road resistance characteristic coefficient from the route-optimized module 24, the current road information from the map data module 22, and the current driving parameters from the computing module 15 to determine the power required of the vehicle and obtain the operation parameters of the engine from the vehicle parameter and engine data module 13 in accordance with the power required of the vehicle.

The vehicle controlling module 17 is connected to the decision module 16 and the engine for receiving the operation parameters of the engine from the decision module 16 and controlling an output of the engine.

The map data module 22 stores map information related to a traveling area of the vehicle and retrieving the current road information in accordance with the information of the current location of the vehicle from the GPS module 11. The current road information includes a gradient, a pavement condition, road information, and dynamic traffic information. The road information is generally utilized to recognize a specific road in an urban area.

The history data module 23 is in communication connection with the plurality of onboard computers 1 for storing a current road resistance characteristic coefficient computed by the computing module 15 of each of the onboard computers when the onboard computer 1 that is carried on the respective vehicle was moved with the respective vehicle to pass the area recently. The history data module 23 analyzes and compares the current road resistance characteristic coefficients from the different ones of the onboard computers 1. Accordingly, the comparison is made to check the computed results from the onboard computers. If any result is found out of the ordinary, an adjustment is made. When a parameter in the history data module and a parameter in the route-optimized module 24 for the same section of the road are compared, recent changes on the road that are not timely shown on the map can be easily discovered.

The route-optimized module 24 is connected with the history data module 23 for retrieving the standard road resistance characteristic coefficient corresponding to the current road information. The route-optimized module 24 further sends the standard road resistance characteristic coefficient corresponding to the information of the current location to the decision module 16 of the onboard computer 1.

A method to save fuel in accordance with actual driving conditions of a vehicle includes a step of collection and record optimization and a step of execution.

The step of collection and record optimization is utilized to enrich the history data module 23, so that the history data module 23 can store and analyze the history data for acquiring optimized data. The step of collection and record optimization includes:

(A1) presetting, in an onboard computer 1 of each of vehicles, configuration parameters of the vehicle and operation parameters of an engine corresponding to the power required of the vehicle and presetting map information related to a traveling area of the vehicle in an information center 2; and

(A2) allowing the onboard computer 1 of each of the vehicles to collect current road information, which is used in combination with the configuration parameters of the vehicle to compute current driving parameters and a current road resistance characteristic coefficient; allowing the onboard computer 1 to retrieve information of a current location of the vehicle; sending a combination of the current road resistance characteristic coefficient and the current location of the vehicle to the information center 2 to be saved as history data, generating a standard road resistance characteristic coefficient corresponding to the current road.

The step of execution helps keep the power of the vehicle stable by utilizing the history data module 23 and the route-optimized module 24 to acquire the standard road resistance characteristic coefficient. The step of execution includes:

(B1) retrieving the standard road resistance characteristic coefficient corresponding to the current location of the vehicle;

(B2) using the current road information, the current driving parameters, and the standard road resistance characteristic coefficient to compute the power required of the vehicle and the operation parameters of the engine in accordance with the power required; and

(B3) controlling an output of the engine in accordance with the operation parameters of the engine.

Accordingly, the present invention utilizes the history data module to record and summarize the current road resistance characteristic coefficients computed by the onboard computers of all the vehicles, so that correspondent standard road resistance characteristic coefficients are retrievable after being analyzed. Subsequently, the decision module 16 calculates the power required of the vehicle according to the current driving parameters, the standard road resistance characteristic coefficient, and the current road information. The operation parameters of the engine are correspondingly obtained from the vehicle parameter and engine data module 13 in accordance with the power required of the vehicle and executed by the vehicle controlling module 17.

Preferably, the self-adjusting system 100 of the engine includes a human-machine interface module 18 for drivers to input the driving data, which includes a load of the vehicle and road features. The decision module 16 determines the power required of the vehicle according to the driving data, the current road information, the standard road resistance characteristic coefficient, and the current driving parameters. By means of the human-machine interface module 18, a manual operation is available, where the self-adjusting system 100 does not carry out self adjustment so that the drivers can directly control and adjust the engine.

The operation of the self-adjusting system 100 is depicted as follows:

When driving the vehicle on the road, the resistance acting on the vehicle mainly includes a driving force and a resistance force. A driving resistance equation is:

Fₜ=F_{f}+F_{w}+Fᵢ+Fⱼ

In the equation, Fₜ is the driving force, F_{f} is the rolling resistance, Fᵢ is the grade resistance, and Fⱼ is the accelerating resistance.

The equation is equal to:

$$\frac{{T}_{tq} {i}_{g} {i}_{0} {η}_{r}}{r} \approx δ ma + mg sin θ + mgf cos θ + \frac{{C}_{D} {Av}^{2}}{21.15}$$

In the equation, T_{tq} is the torque of the engine, i_{g} is the ratio of gear box, i₀ is the ratio of final drive, r is the wheel rolling radius, η_{τ} is the transmission efficiency, δ is the coefficient of the revolving mass changes to a linear mass, m is the mass of the vehicle, a is the acceleration of the vehicle, g is the acceleration of gravity, f is the rolling resistance coefficient, θ is the road gradient, ν is the speed of the vehicle, C_{D} is the drag coefficient, and A is the frontal area.

Aforementioned equation can be changed to:

$$λ = ( sin θ + f cos θ ) = \frac{\frac{{T}_{tq} {i}_{g} {i}_{0} {η}_{r}}{r} - \frac{{C}_{D} {Av}^{2}}{21.15} - δ ma}{mg}$$

where λ is the road resistance characteristic coefficient.

The engine torque T_{tq} and the speed of the vehicle v can be acquired from the CAN network, or acquired from a corresponding controller. The coefficients i_{g}, i₀, r, η_{τ}, δ, C_{D}, and A are preset in the vehicle parameter and engine data module 13 of the onboard computers 1. When the speed of the vehicle is obtained by a smooth process, the acceleration a can be computed by the change rate of the speed of the vehicle.

$$a = \frac{( {v}_{10} + {v}_{9} + {v}_{8} + {v}_{7} + {v}_{6} ) - ( {v}_{5} + {v}_{4} + {v}_{3} + {v}_{2} + {v}_{1} )}{5 T}$$

where T is the sampling period of the vehicle speed, ν₁ to ν₁₀ is the speed value recorded in the last ten sampling points of a sampling period and ν₁₀ is the latest speed value.

Moreover, when the change rate of the accelerator pedal is fast, the torque of the engine changes abruptly. Since the mass of the vehicle is too big to follow the fast change rate of the torque of the engine, the value of λ computed tends to be inaccurately enlarged, which should therefore be filtered out. Namely, the computation is merely made when the accelerator pedal smoothly changes; any abnormal value of the torque of the engine is filtered out with the rest of the normal values of the torque of the engine included by smooth processing for the driving data collecting module 12 to obtain the current position of the accelerator pedal and the position of the accelerator pedal during braking. The same rationale is also true of the gear. Namely, when the current value of the gear is abnormal or irregular, the resistance characteristic coefficient λ accordingly computed is not to be taken into account with the improper gear resulting in an abnormal coefficient of the torque. The mass m of the vehicle includes not only the complete vehicle kerb mass (i.e. unladen mass of a vehicle ready to drive, with no occupants but normal oil, water, and fuel levels) but also the human-machine interface module 18 for allowing drivers to input related data (such as add-on weight of passengers or cargo). Accordingly, the current load of the vehicle is updated with the user's input data.

In the decision process, the current road resistance characteristic coefficient λ computed by the route-optimized module 24 presents the characteristic of the roads, including the gradient and the state of the road. The power required of the vehicle on the current road is calculated by the following equation:

$${F}_{t} = ( mg λ + \frac{{C}_{D} {Av}^{2}}{21.15} ) \cdot α \cdot β$$

Under toleration, if the speed limit of the road is less than the calculated economical speed, the speed limit of the road is the value ν. If the calculated economical speed per hour is less than the speed limit of the road, the calculated economical speed per hour is the value ν. Therefore, the value is subject to real-time road information. Namely, if the traffic on the road is jammed, the value changes, and the real-time traffic information defines a qualitative description, such as jammed, or unhindered, according to the state of the road. Moreover, the qualitative description is also defined as “The average vehicle speed of the road is 20 km/h.” Then, 20 km/h is the value ν since the value presents the speed of the vehicle in the real-time traffic situation, the condition of the road is therefore realized.

In the equation, α is a reserve-power coefficient; it is a fixed value related to the type of the vehicle. The reserve-power coefficient guarantees that the vehicle has enough power to accelerate. The value of this reserve-power coefficient is decided by correlated regulations of the vehicle power and the experience of the driver to keep the acceleration of the vehicle under reasonable range. β is a route coefficient; this coefficient is influenced by the input from a human-machine interface. For example, for an express lane or a road that has a time limit, the value β is augmented to present enough vehicle power.

A tractive force Fₜ is computed below. The ratio i₀ is decided by the economical gear under the vehicle speed ν. According to the two initial equations:

$${F}_{t} = {F}_{f} + {F}_{w} + {F}_{i} + {F}_{j}$$

$$\frac{{T}_{tq} {i}_{g} {i}_{0} {η}_{r}}{r} \approx δ ma + mg sin θ + mgf cos θ + \frac{{C}_{D} {Av}^{2}}{21.15}$$

$${F}_{t} = \frac{{T}_{tq} {i}_{g} {i}_{0} {η}_{r}}{r}$$

is obtained after calculating the maximum torque T_{tq} of the engine. The equation P=Ft*ν computes the maximum power required of the engine. The power required of the vehicle is the greater of the maximum torque and the maximum power.

Consequently, the operation parameters of the engine are acquired from the vehicle parameter and engine data module. The vehicle controlling module 17 adjusts the response from the accelerator pedal of the engine to reduce adverse influences resulted from the improper driving manners. Moreover, the standard road resistance characteristic coefficient is an optimized value acquired by taking into account many vehicles and is thus a more reliable reference in controlling the output of the engine.

While we have shown and described the embodiment in accordance with the present invention, it should be clear to those skilled in the art that further embodiments may be made without departing from the range of the present invention.

I claim:

1. A self-adjusting system for an engine of a vehicle, comprising:
an information center; and
a plurality of onboard computers respectively mounted on a plurality of vehicles and in communication connection with the information center, each of the onboard computers comprising:
a global positioning system (GPS) module that acquires information of a current location of the vehicle and sends the information to the information center;
a driving data collecting module that collects driving data of the vehicle, including vehicle speed, engine speed, engine torque, a position of an accelerator pedal, and a position of a brake pedal;
a vehicle parameter and engine data module that stores therein vehicle configuration parameters and engine operation parameters corresponding to various values of power;
a computing module that computes current driving parameters based on the driving data from the driving data collecting module;
the current driving parameters including vehicle acceleration, a change rate of the accelerator pedal position, and a gear of the vehicle, the computing module working on the vehicle configuration parameters from the vehicle parameter and engine data module so as to figure out a current road resistance characteristic coefficient;
a decision module that determines power required of the vehicle according to a standard road resistance characteristic coefficient from a route-optimized module, current road information from a map data module, and the current driving parameters from the computing module and retrieves corresponding engine operation parameters from the vehicle parameter and engine data module in accordance with the power required of the vehicle; and
a vehicle controlling module that receives the engine operation parameters and controls an output of the engine; and
the information center including:
a map data module that stores map information and retrieves the current road information in accordance with the information of the current location of the vehicle from the GPS module;
a history data module that is in communication connection with the onboard computers of the plurality of vehicles to receive and store the current road resistance characteristic coefficient computed by the computing module of the onboard computer of each of the vehicle that was passing the road recently, the history data module conducting analysis and comparison of the current road resistance characteristic coefficients from the plurality of onboard computers of the plurality of vehicles; and
a route-optimized module connected with the history data module to retrieve the standard road resistance characteristic coefficient corresponding to the current road information and sending the standard road resistance characteristic coefficient corresponding to the current location to the decision module of the onboard computer of the vehicle.

2. The self-adjusting system as claimed in claim 1, wherein each onboard computer includes a human-machine interface module for drivers to input the driving data that includes a vehicle load and a state of the road; the decision module determines the power required of the vehicle according to the current road information, the standard road resistance characteristic coefficient, and the current driving parameters.

3. The self-adjusting system as claimed in claim 1, wherein the vehicle configuration parameters include a ratio of gearbox, a ratio of final drive, a maximum total mass of the vehicle, a wheel rolling radius, transmission efficiency, a coefficient of the revolving mass changes to a linear mass, a drag coefficient, and a frontal area.

4. The self-adjusting system as claimed in claim 1, wherein the current road information includes a gradient, a pavement condition, road information, and dynamic traffic information.

5. A method for saving fuel in accordance with a driving state of a vehicle, comprising a step of collection and record optimization and a step of execution, the step of collection and record optimization comprising:
(A1) presetting, in an onboard computer of each of vehicles, configuration parameters of the vehicle and operation parameters of an engine corresponding to the power required of the vehicle and presetting map information related to a traveling area of the vehicle in an information center; and
(A2) allowing the onboard computer of each of the vehicles to collect current road information, which is used in combination with the configuration parameters of the vehicle to compute current driving parameters and a current road resistance characteristic coefficient; allowing the onboard computer to retrieve information of a current location of the vehicle; sending a combination of the current road resistance characteristic coefficient and the current location of the vehicle to the information center to be saved as history data, generating a standard road resistance characteristic coefficient corresponding to the current road; and
the step of execution including:
(B1) retrieving the standard road resistance characteristic coefficient corresponding to the current location of the vehicle;
(B2) using the current road information, the current driving parameters, and the standard road resistance characteristic coefficient to compute the power required of the vehicle and the operation parameters of the engine in accordance with the power required; and
(B3) controlling an output of the engine in accordance with the operation parameters of the engine.

6. The method as claimed in claim 5, wherein step (A1) further comprises a step of providing a human-machine interface module for drivers to input the driving data that includes a vehicle load and a state of the road; in step (A2), the vehicle load is used in combination in computing the current driving parameters; in step (B2) the road information, the standard road resistance characteristic coefficient, and the current driving parameters are used in combination to determine the power required of the vehicle.

7. The method as claimed in claim 5, wherein the vehicle configuration parameters include a ratio of gearbox, a ratio of final drive, a maximum total mass of the vehicle, a wheel rolling radius, transmission efficiency, a coefficient of the revolving mass changes to a linear mass, a drag coefficient, and a frontal area.

8. The method as claimed in claim 5, wherein the road information includes vehicle speed, engine speed, engine torque, a position of an accelerator pedal, and a position of a brake pedal and the current driving parameters include a resistance, an acceleration of the vehicle, a change rate of the accelerator pedal position, and a gear of the vehicle.

9. The method claimed in claim 5, wherein the current road information includes a gradient, a pavement condition, a road information, and dynamic traffic information.
